(19) United States
(12) Patent Application Publication
(10) Pub. No.: US 2024/0259738 A1
(43) Pub. Date: Aug. 1, 2024

(54) METHOD FOR OPERATING A HEARING DEVICE, HEARING DEVICE AND HEARING DEVICE SYSTEM

(71) Applicant: Sivantos Pte. Ltd., Singapore (SG)

(72) Inventors: Nishshanka Bandara Narampanawe, Singapore (SG); Heng Goh Yap, Singapore (SG)

(21) Appl. No.: 18/428,655

(22) Filed: Jan. 31, 2024

(30) Foreign Application Priority Data
Jan. 31, 2023 (DE) 10 2023 200 779.7

(51) Int. Cl. H04R 25/00; H02J 50/10

(52) U.S. Cl. CPC H04R 25/554; H02J 50/10; H04R 25/602; H04R 2225/31; H04R 2225/55

(57) ABSTRACT

A method operates a hearing device, in particular a hearing aid device, which contains an inductive charging unit that has a receiving coil, and a battery that is electrically connected via a communication unit to the charging unit. An electric voltage applied at the receiving coil is changed by the communication unit in dependence on data to be transferred to the charging unit. Furthermore, a hearing device and a hearing device system incorporate the operating method.

### CROSS-REFERENCE TO RELATED APPLICATION

This application claims the priority, under 35 U.S.C. § 119, of German Patent Application DE 10 2023 200 779.7, filed Jan. 31, 2023; the prior application is herewith incorporated by reference in its entirety.

### FIELD AND BACKGROUND OF THE INVENTION

The invention relates to a method for operating a hearing device and also a hearing device and a hearing device system. In each case, the hearing device has an inductive charging unit.

Persons who suffer from a loss of the sense of hearing typically use a hearing device which is a hearing aid. In this case, ambient sound is usually converted into an electric (audio/sound) signal by means of a microphone, i.e. an electromechanical sound transducer, so that the electric signal is acquired. The acquired electric signals are processed by an amplifier circuit and introduced by means of a further electromechanical transducer in the form of a receiver into the auditory canal of the person. Moreover, the acquired sound signals are usually processed, for which a signal processor of the amplifier circuit is typically used. In this case, the amplification is adapted to a possible hearing loss of the hearing aid wearer. The (sound) transducers and the amplifier circuit are typically arranged in a housing and as such at least partially protected from environmental influences.

A battery is normally used to power the individual components of the hearing device, such as the amplifier circuit and the sound transducer. It is configured, for example, as an exchangeable secondary battery, which can be removed from the housing and charged outside the housing. As a result, it is necessary for the housing to have a minimum size so that it is possible to remove the battery manually. If the structural size of the housing is reduced further, such a removal is no longer possible. In this case, the battery is permanently installed and is charged inside the housing. In order that as few openings as possible are present in the housing in this case, through which, for example, foreign particles can enter the housing, a charging unit is increasingly being provided in the housing, which has a receiving coil and is electrically connected to the battery. To charge the battery, the receiving coil is inductively excited by means of an external charger, so that wireless charging of the battery and thus of the hearing aid device takes place. In other words, it is an inductive charging unit.

With increasing state of charge of the battery, the electric current flowing between the receiving coil and the battery is reduced, which results in a reduced energy transfer between the charger and the charging unit. This is monitored by means of a corresponding monitoring unit of the charger so that the state of charge of the battery can be displayed there without a separate communication connection being necessary. It is therefore possible, for example, to switch off the charger when the battery has been fully charged.

In one refinement, a communication unit is provided in the hearing device, which is electrically connected in parallel to the battery and is electrically connected to the charging unit. An electric current flow is provided if needed by means of the communication unit, so that a course of the energy transfer changing over time results on the part of the charger. With a corresponding setting of the electric currents provided by means of the communication unit, it is thus also possible to transfer other information from the hearing device to the charger.

Electric losses arise during operation of the charging unit, which result in heating of the charging unit and thus of the hearing device. If there is excessive heating, it is possible in this case that the performance of the battery will decrease. A maximum operating time of the hearing aid device between two charging processes is thus reduced. The electric losses occur, inter alia, in the receiving coil, wherein they are dependent on the level of the electric currents conducted thereby. If electric currents are additionally provided here by means of the communication unit, the electric losses are increased.

### SUMMARY OF THE INVENTION

The invention is based on the object of specifying a particularly suitable method for operating a hearing device and a particularly suitable hearing device and also a particularly suitable hearing device system, wherein, in particular, occurring electric losses are reduced.

This object is achieved with respect to the method by the features of the independent method claim with respect to the hearing device by the features of the independent hearing device claim, and with respect to the hearing device system by the features of the independent hearing device system claim.

Advantageous refinements and embodiments are subject matter of the dependent claims.

The method is used for operating a hearing device. For example, the hearing device is a headphone or comprises a headphone, and the hearing device is, for example, a headset. However, the hearing device is particularly preferably a hearing aid device. The hearing aid device is used to assist a person suffering from a loss of the sense of hearing. In other words, the hearing aid device is a medical device by means of which, for example, a partial hearing loss is compensated for. The hearing aid device is, for example, a “receiver-in-the-canal” hearing aid device (RIC; ex-receiver hearing aid device), an in-ear hearing aid device, such as an “in-the-ear” hearing aid device, an “in-the-canal” hearing aid device (ITC), or a “complete-in-canal” hearing aid device (CIC), hearing aid glasses, a pocket hearing aid device, a bone vibrator hearing aid device, or an implant. Alternatively, the hearing aid device is a behind-the-ear hearing aid device, which is worn behind a pinna.

The hearing device is provided and configured to be worn on the human body. In other words, the hearing device preferably includes a holding device, by means of which fastening on the human body is possible. If the hearing device is a hearing aid device, the hearing device is provided and configured to be arranged for example behind the ear or inside an auditory canal. In particular, the hearing device is wireless and is provided and configured to be inserted at least partially into an auditory canal.

The hearing device comprises, for example, a microphone, which is used to acquire sound. In particular, an ambient sound, i.e. sound waves, or at least a part thereof, is acquired by means of the microphone during operation.

The microphone is suitably an electromechanical sound transducer. The microphone has, for example, only a single microphone unit or multiple microphone units, which interact with one another. Each of the microphone units expediently has a membrane, which is set into vibrations by means of sound waves, wherein the vibrations are converted by means of a corresponding pickup device, such as a magnet moved in a coil, into an electric signal. It is thus possible to acquire an audio signal by means of the respective microphone unit which is based on the sound, namely in particular the ambient sound, which is incident on the microphone unit. The microphone units are preferably configured as omnidirectional. The microphone is expediently arranged at least partially inside a housing of the hearing device and is thus at least partially protected.

The hearing device expediently has a receiver to output an output signal. The output signal is in particular an electric signal in this case. The receiver is an electromechanical sound transducer, preferably a loudspeaker.

Depending on the design of the hearing device, in the intended state the receiver is arranged at least partially inside an auditory canal of a wearer of the hearing aid, i.e. a person, or is at least acoustically connected thereto. The hearing device is primarily used in particular to output the output signal by means of the receiver, wherein a corresponding sound is created. In other words, the main function of the hearing device is the output of the output signal. The output signal is created in particular at least partially depending on the sound acquired by means of the microphone.

The hearing device expediently contains a signal processor, which suitably forms a signal processing unit or is at least one component thereof.

However, the hearing device expediently at least contains a corresponding signal processing unit. The signal processor is, for example, a digital signal processor (DSP) or is implemented by means of analog components. An adaptation of the (audio) signal created by means of the possible microphone is in particular carried out by means of the signal processor, preferably depending on possible hearing loss of a wearer (user, operator) of the hearing device. An

A/D converter is expediently arranged between the microphone and the signal processing unit, for example the signal processor, if the signal processor is configured as a digital signal processor. The signal processor is set in particular depending on a parameter set. An amplification in different frequency ranges is predetermined here by means of the parameter set, so that the signal created by means of the microphone is processed according to defined specifications, in particular depending on a hearing loss of the wearer of the hearing device. The hearing device particularly preferably additionally has an amplifier, or the amplifier is at least partially formed by means of the signal processor. For example, the amplifier is connected upstream or downstream of the signal processor for signaling.

The hearing device has a battery, by means of which during operation in particular further components of the hearing device are powered, such as the possible microphone, the possible signal processing unit, and/or the possible receiver. The battery is preferably a secondary battery and is suitably installed permanently, i.e. in particular non-detachably, in the possible housing of the hearing device.

Moreover, the hearing device has an inductive charging unit, which is suitably arranged inside the possible housing of the hearing device. The charging unit is used to charge the hearing device, in particular the battery. The inductive charging unit, which is also designated hereinafter solely as charging unit, is suitable, in particular provided and configured, for this purpose. The charging unit is suitable, expediently provided and configured, for wireless charging in this case. The charging unit has a receiving coil, in which an electric voltage can be induced by means of an (external) charger by a magnetic field variable over time being provided by means of the charger. The receiving coil is suitable, in particular provided and configured, for this purpose. In other words, the receiving coil is used in particular for transferring, preferably namely receiving, energy from the charger to the hearing device.

The charging unit is electrically connected to the battery so that energy received by means of the receiving coil can be fed into the battery. An electric current flow to the battery results here in particular due to the electric voltage induced in the receiving coil, and so the battery is charged. The charging unit suitably contains a rectifier, so that a direct current is provided by means thereof, which simplifies the charging of the battery. For example, the rectifier is formed by means of a single diode or the rectifier is designed as a bridge rectifier. The charging unit expediently comprises a capacitance, such as a capacitor, by means of which variations in the electric current are evened out, so that the battery is charged with an essentially constant electric current if an electric voltage is induced in the receiving coil.

The hearing device furthermore contains a communication unit, which is used in particular for communication of the hearing device with further components, preferably the charger, and is suitable, in particular provided and configured, for this purpose. The communication unit is arranged in this case between the charging unit and the battery, so that the charging unit is electrically connected via the communication unit to the battery. The electric current used for charging the battery is thus guided via the communication unit. Data or items of information, which are to be transferred from the hearing device to the further component, are preferably provided by means of the communication unit in particular to the possible charger. The data are in particular items of status information of the hearing device in this case.

The method provides that an electric voltage applied at the receiving coil is changed by means of the communication unit as a function of data to be transferred. The method is carried out in particular during the charging of the hearing device in this case, i.e. when an electric voltage is induced in the receiving coil preferably by means of the (external) charger, as a result of which an electric current flow to the battery results, so that it is charged.

The electric voltage applied at the receiving coil is influenced by means of the communication unit so that the energy transfer from the charger to the charging unit is also changed, which is acquired in particular on the basis of voltage variations resulting in the charger, in particular at the electric coil used for the transfer of the energy. The voltage variations correspond to the data, and so the data provided by the hearing device can be decrypted in the charger by means of corresponding decoding.

The data are preferably coded by means of the communication unit and preferably converted into a binary system. Two states are thus present, and the electric voltage applied at the receiving coil is switched between the two states by means of the communication unit. A comparatively robust transfer of data is thus enabled. Alternatively thereto, additional states are also provided, so that, for example, the electric voltage applied at the receiving coil can assume more than two different dimensions. A bandwidth is thus increased. In summary, a voltage modulation of the electric voltage applied at the receiving coil is carried out by means of the communication unit, wherein the data to be transferred are stored in the modulation.

As a result of the method, the electric currents conducted by means of the receiving coil are not excessively increased during the transfer of data, as a result of which no additional losses which result in excessive heating occur. A usability of the battery is thus increased and a degeneration thereof is slowed. However, at least a strain due to excessive heating is reduced. Since variations in the amount of energy transferred result during the transfer of data in the charger, it is possible to use an already existing charger in which variations in the energy exchanged between the charger and the hearing device are induced for transferring data.

For example, the battery is directly connected to the charging unit via the communication unit, or preferably via a charge controller. The charge controller and the battery expediently form a battery unit. The electric current provided by means of the charging unit is in particular adapted in this case by means of the charge controller, in particular as a function of a state of charge of the battery. It is thus possible to further extend a usage period of the battery.

An electric resistance of the communication unit is particularly preferably set as a function of the data to be transferred.

In particular, for this purpose the electric resistance of the communication unit is changed between two values, for which purpose, for example, a switch is connected in parallel to an electric component which has a specific electric resistance. The electric component is bypassed by means of the switch, so that it only contributes to providing the electric resistance when the switch is open.

Due to the series connection of the communication unit to the battery, the electric voltage applied at the receiving coil is therefore essentially either solely equal to the electric voltage provided by means of the battery, which is approximately constant over at least comparatively short time intervals, or plus the electric voltage arising via the electric component, wherein the change between these different electric voltages is carried out in accordance with the data to be transferred. A comparatively simple change of the electric voltage applied at the receiving coil is therefore possible.

The hearing device is, for example, a headset or particularly preferably a hearing aid device. For example, the hearing aid device is a “receiver-in-the-canal” hearing aid device (RIC; ex-receiver hearing aid device), an in-ear hearing aid device, such as an “in-the-ear” hearing aid device, an “in-the-canal” hearing aid device (ITC), or a “complete-in-canal” hearing aid device

(CIC), hearing device glasses, a pocket hearing aid device, a bone vibrator hearing aid device, or an implant. Alternatively, the hearing aid device is a behind-the-ear hearing aid device, which is worn behind a pinna.

The hearing device has an inductive charging unit, a battery, and a communication unit, wherein the battery is electrically connected via the communication unit to the charging unit. The battery is preferably a secondary battery, and/or the battery is used to power a possible receiver, microphone, and/or a signal processing unit. In particular, the battery is essentially used to power all further components of the hearing device.

The charging unit is used for wirelessly charging the hearing device, expediently the battery of the hearing device. The charging unit is used in particular for wirelessly receiving electric energy, so that wireless charging of the hearing device is possible by means of the charging unit, in particular so-called “wireless charging”. The charging unit has a receiving coil which is excited in particular by means of an external charger in operation, so that an electric (AC) voltage is induced therein. In particular, an inductive excitation of the receiving coil thus takes place. The receiving coil is in particular suitable, preferably provided and configured, for this purpose in each case. The receiving coil is preferably formed hollow cylindrical or planar. The receiving coil expediently at least has multiple terms which are structurally identical to or different from one another, for example. The receiving coil is suitably produced from an electrically conductive material, such as for example a metal, suitably aluminum or copper. The number of turns is preferably equal to two. The receiving coil has, for example, an inductance between 50 nH and 500 nH.

The hearing device is operated according to a method in which by means of the communication unit, an electric voltage applied at the receiving coil, which is in particular an electric AC voltage, is changed as a function of data to be transferred. In particular, the method is thus used to transfer data. To change the electric voltage applied at the receiving coil, an amplitude of the applied electric (AC) voltage and/or a phase of the applied electric voltage is expediently changed, wherein in particular only two states which the applied electric voltage can assume are expediently present, in particular two different amplitudes. Due to the method, no additional communication channel for transferring data between the hearing device and the possible external charger is thus required. The electric currents conducted using the receiving coil, which result in particular due to the electric voltage induced therein, are thus reduced or at least limited, so that electric losses are reduced.

In particular, the hearing device contains a control unit, which is suitable, in particular provided and configured, to carry out the method, and/or the method is at least partially carried out by means of the communication unit.

The communication unit expediently at least partially forms the control unit. The control unit is preferably implemented by means of discrete components or it comprises a microcontroller which is designed to be programmable, for example.

In a further alternative, the control unit is designed as an application-specific integrated circuit (ASIC).

The communication unit expediently comprises a diode, by means of which the charging unit and the battery are electrically connected. In this case, the diode is bypassed by means of a switching element such that the charging unit and the battery are also electrically connected by means of the switching element. The communication unit thus has two branches by means of which the charging unit is electrically connected to the battery, wherein one of the branches is assigned the diode and the other is assigned the switching element. The diode is preferably arranged such that an electric current flow from the charging unit to the battery is always possible. The charging of the battery therefore always takes place when an electric voltage is applied at the receiving coil, independently of the transfer of the data, and so the time required for charging the battery is reduced. It is therefore also possible to charge the battery using an essentially constant electric current, such that a strain of the battery is reduced.

It is possible by means of the switching element to change the electric voltage applied at the receiving coil. If the switching element is open, the electric voltage applied at the receiving coil is determined by means of the electric voltage provided by means of the battery and the electric voltage arising via the diode. In contrast, if the switching element is closed, preferably essentially no electric voltage drops across the communication device, and so the electric voltage applied at the receiving coil is reduced and expediently corresponds to the electric voltage provided by means of the batteries. The electric voltage applied at the receiving coil is also at least influenced by means of the branch which has the switching element.

The switching element is, for example, connected in parallel to the diode. In other words, no further components are present in this circuit.

However, the diode is particularly preferably electrically connected in series to at least one further electric/electronic component, wherein the series circuit is bypassed using the switching element. The switching element is preferably connected in parallel to the series circuit. The further component is particularly preferably a second diode, the blocking direction of which is in particular identical to the blocking direction of the diode. Due to the second diode, the electric voltage arising via the communication unit when the switching element is open is increased, and so a change of the amount of energy or at least of the electric voltage applied at the charger is also increased. Acquiring and/or decoding the data transferred from the hearing device is thus facilitated. The charging of the battery is essentially not influenced here due to the two diodes. In one refinement, multiple such diodes, or at least second diodes, are present.

The switching element is expediently a semiconductor switch, which thus has a control input. For example, the data to be transferred are applied directly to the control input, and so design is simplified. In this case, the data are in particular provided already coded, wherein at one applied level in particular the switching element is switched into the conductive state, and wherein it is otherwise in an electrically nonconductive state. The switching element is preferably a field-effect transistor, which thus has a gate, drain, and a source. The data are, for example, directly applied to the gate in this case.

However, the gate is particularly preferably connected via a voltage source to its source. An electric DC voltage is provided in this case by means of the voltage source. A resistor is particularly preferably electrically connected in series with the voltage source, and so an electric current flowing between the gate and the source is limited. The voltage source is bypassed by means of a further switching element. If the further switching element is closed, the gate is thus electrically contacted with the source with low resistance, as a result of which the switching element is in particular electrically nonconductive. The electric voltage provided by means of the voltage source only acts on the gate when the further switching element is open, and so the switching element is electrically conductive. The further switching element is actuated in particular as a function of the data to be transferred, wherein only comparatively small currents are conducted thereby and/or a comparatively small electric voltage is applied. It is thus possible to design the further switching element comparatively cost-effectively.

The further switching element is particularly preferably also a field-effect transistor, the gate of which is connected via a further voltage source to its source. Moreover, a further resistor is particularly preferably electrically connected in series with the voltage source in this case, such that a current flow between the gate and the source of the further switching element is limited. The further voltage source is particularly preferably led toward a data input in this case. In particular, the data to be transferred are provided in coded form at the data input in operation. The electric voltage provided by means of the further voltage source is preferably influenced on the basis of the data, for example increased or decreased, such that the second switching element is electrically conductive or electrically nonconductive as a function of the data provided at the data input. As a function thereof, the switching element is electrically conductive and the diode is thus short-circuited, or the diode contributes to the electric resistance of the communication unit. In particular, the data input is arranged between the possible further resistor and the further voltage source, preferably on the side of the gate with respect to the further voltage source.

The battery is particularly preferably bypassed using a capacitance, which is preferably designed as a capacitor. The electric voltage applied at the receiving coil is in particular at least implicitly specified by means of the capacitance, wherein no time dependence is present, however. The electric current conducted to the battery is preferably smoothed by means of the capacitance and preferably kept essentially constant, even if the electric voltage applied at the receiving coil is changed by means of the communication unit. A strain of the battery is thus reduced. In particular, the diode and the switching element are present in this case. If the switching element is closed, the resistance provided by means of the communication unit is comparatively small, and the capacitance is in particular electrically contacted directly with the charging unit, and so essentially immediate charging of the capacitance takes place. In contrast, if the switching element is open, an electric current flow is reduced, as a result of which the battery is at least partially fed from the capacitance.

The hearing device system has a hearing device, which contains an inductive charging unit that has a receiving coil, and a battery that is electrically connected via a communication unit to the charging unit.

Furthermore, the hearing device system has a charger, which is also designated as external charger. The charger is used for the inductive charging and has in particular an electric coil and an activation circuit, by means of which an AC voltage is applied in operation to the coil of the charger, such that a magnetic field changing over time results. This field interacts in particular with the receiving coil of the hearing device when they have a comparatively small distance from one another. The frequency of the applied AC voltage is expediently matched to the hearing device. In particular, the charger and the hearing device are separate components from one another and can be moved away from one another. They are suitably only moved toward one another for charging the hearing device namely its battery. For example, the charger has a holding device for fastening or at least temporarily holding the hearing device.

The hearing device system is preferably operated according to a method which is used in particular for charging the hearing device, namely expediently its battery. An electric AC voltage is applied in this case to the electric coil of the charger. When the hearing device is in the vicinity of the charger, an electric voltage is induced in the receiving coil, which results in an electric current flow from the receiving coil to the battery. An energy transfer thus takes place from the charger to the hearing device. The amount of energy transferred is suitably determined by means of a monitoring unit of the charger in this case, for which the electric voltage applied at the electric coil and the electric current conducted thereby are acquired. An electric voltage applied at the receiving coil is changed by means of the communication unit as a function of data to be transferred. As a result, the amount of energy transferred from the charger to the hearing device changes, which is acquired by means of the monitoring unit. The change of the amount of energy corresponds here to the change of the electric voltage and thus also to the transferred data. Data are thus transferred from the hearing device to the charger by means of the method.

The refinements and advantages explained in conjunction with the method are also to be transferred accordingly to the hearing device/the hearing device system and among one another and vice versa.

Other features which are considered as characteristic for the invention are set forth in the appended claims.

Although the invention is illustrated and described herein as embodied in a method for operating a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration schematically showing a hearing device system which has a hearing device and a charger according the invention;

FIG. 2 is schematic showing a detail of a circuit diagram of the hearing device system in simplified form;

FIG. 3 is a flow chart showing a method for operating the hearing device;

FIG. 4 is a graph showing time curves of electric voltages applied at different components of the hearing device system; and

FIG. 5 is a schematic showing an alternative embodiment of a communication unit of the hearing device.

### DETAILED DESCRIPTION OF THE INVENTION

Mutually corresponding parts are provided with the same reference signs in all figures.

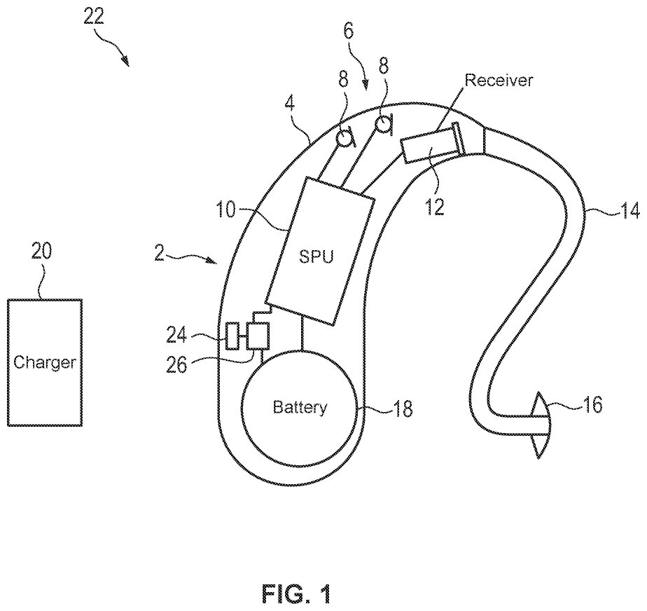

Referring now to the figures of the drawings in detail and first, particularly to FIG. 1 thereof, there is shown schematically a hearing device 2 in the form of a hearing aid device, which is provided and configured to be worn behind an ear of a wearer (user, hearing aid wearer). In other words, it is a behind-the-ear hearing aid device. The hearing device 2 contains a housing 4 manufactured from plastic. A microphone 6 having two microphone units 8 in the form of an electromechanical sound transducer in each case, which are designed to be omnidirectional, is arranged inside the housing 4. A time offset between the acoustic signals acquired by means of the omnidirectional microphone units 8 being changed makes it possible to change a directional characteristic of the microphone 6, thus implementing a directional microphone.

The two microphone units 8 are coupled with respect to signaling to a signal processing unit 10, which comprises an amplifier circuit (not shown in more detail) and a signal processor. The signal processing unit 10 is furthermore formed by means of circuit elements, such as for example electric and/or electronic components. The signal processor is a digital signal processor

(DSP) and is connected with respect to signaling to the microphone units 8 via an non-illustrated A/D converter.

A receiver 12 is coupled with respect to signaling to the signal processing unit 10. By means of the receiver 12, which is an electromechanical sound transducer, an (electric) signal provided by means of the signal processing unit 10 is converted into an output sound, i.e. into sound waves, in operation. These sound waves are introduced into a sound tube 14, one end of which is fastened on the housing 4. The other end of the sound tube 14 is enclosed by means of a dome 16, which in the intended state is arranged in an auditory canal (not shown in greater detail here) of the wearer of the hearing device 2.

The signal processing unit 10 is powered by means of a battery 18 arranged in the housing 4. A part of the electric energy is conducted to the microphone 6 and to the receiver 12 by the signal processing unit 10. The electric energy emitted from the battery 18 in operation of the hearing device 2 is provided wirelessly by an (external) charger 20 in a charging process of the hearing device 2. The charger 20 and the hearing device 2 form a hearing device system 22, wherein the hearing device 2 and the charger 20 are two components separate from one another. It is thus possible to move them independently of one another, wherein the charger 20 expediently has a holding device (not shown in greater detail) by means of which the hearing device 2 is held during charging.

The electric energy provided by the charger 20 is wirelessly received by an inductive charging unit 24 of the hearing device 2. The charging unit 24 is electrically connected via a communication unit 26 to the battery 18, such that the electric energy received by means of the charging unit 24 can be conducted to the battery 18. The communication unit 26 is moreover connected with respect to signaling to the signal processing unit 10, and in operation data to be transferred to the charger 20 are requested from the signal processing unit 10 by means of the charger 20. In summary, the hearing device system 22 is designed for inductive charging, i.e. for wireless energy transfer from the charger 20 to the hearing device 2. Communication is also to take place here between the hearing device 2 and the charger 20.

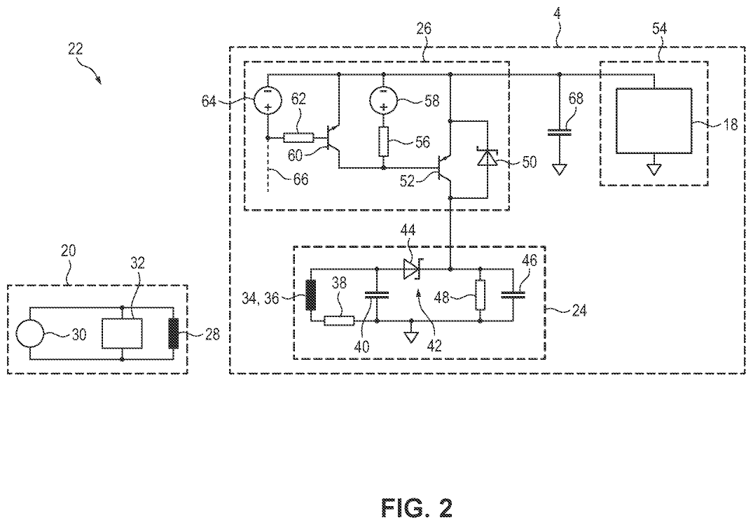

FIG. 2 schematically shows in simplified form a detail of a circuit diagram of the hearing device system 22. The charger 20 has an electric coil 28, which has an inductance of 100 nH and which is activated by means of an activation circuit 30. An electric AC voltage is applied for this purpose to the electric coil 28 by means of the activation circuit 30, which has multiple electric and/or electronic components (not shown in greater detail), such that an alternating current results through the electric coil 28. As a consequence, a magnetic field results in the surroundings of the charger 20. The charger 20 furthermore contains a monitoring unit 32, by means of which the electric voltage applied to the electric coil 28 and the electric current flowing through the electric coil 28 are acquired. The dimension of an energy transfer from the charger 20 to the hearing device 2 is determined therefrom.

The hearing device 2, namely the charging unit 24, has a receiving coil 34 in which an electric voltage is induced as a result of the magnetic field created by means of the electric coil 28, and so an electric voltage 36 is applied to the receiving coil 34, which results in an electric current. The receiving coil 34 is electrically connected in series to a first resistor 38 and a first capacitor 40.

The first resistor 38 is, for example, a parasitic resistance of the receiving coil 34 and/or of the electric lines used. The inductance of the receiving coil 34 is 230 nH and the resistance of the first resistor 38 is 0.5 ohm. The capacitance of the first capacitor 40 is 600 pF. A resonant circuit is thus formed here, the resonance frequency of which is matched to the AC voltage provided by means of the activation circuit 30.

A rectifier 42, which is essentially formed using an auxiliary diode 44, is connected in parallel to the receiving coil 34. It is ensured by means of the rectifier 42 that if an electric current flows through the receiving coil 34, it can flow out of the resonant circuit in one direction. A second capacitor 46 is connected in parallel to the rectifier 42, the capacitance of which is 100 nF. The second capacitor 46 is therefore charged by means of the electric current flowing via the diode 44. A second resistor 48, the resistance of which is 100 kiloohms, is connected in parallel thereto. In one refinement, the second resistor 48 is not present and the resistance of 100 kiloohms results when the battery is completely charged or is at least not being charged.

The communication unit 26 is connected to the side of the rectifier 42 facing away from the receiving coil 34, and therefore to the receiving coil 34 at least via the auxiliary diode 44. The communication unit 26 is therefore also connected to the second capacitor 46, by means of which an essentially constant current flow from the charging unit 24 to the communication unit 26 is ensured, even if an electric alternating current results through the receiving coil 34. The communication unit 26 has a diode 50 here, which is connected to the charging unit 24, namely the second capacitor 46. A switching element 52 is connected in parallel to the diode 50, and the switching element 52 and the diode 50 are electrically connected to the battery 18. The diode 50 is arranged such that a current flow from the charging unit 24 to the battery 18 is always possible. In the reverse direction, this current flow is suppressed via the diode 50 and is only possible via the closed switching element 52. In summary, the charging unit 24 and the battery 18 are electrically connected by means of the diode 50, which is bypassed by means of the switching element 52.

The battery 18 is a component of a battery unit 54, which comprises a non-illustrated charge controller by means of which an electric voltage applied to the battery 18 and/or an electric current introduced into the battery 18 is at least slightly adapted. In other words, the electric current provided directly by the charging unit 24 and conducted via the communication unit 26 is not always used to charge the battery 18, but rather an adaptation is carried out by means of the charge controller, in particular as a function of the state of charge of the battery 18.

The switching element 52 is designed as a field-effect transistor, wherein the “source” of the field-effect transistor is located on the side of the battery 18, and the “drain” on the side of the charging unit 24. The gate of the field-effect transistor is connected via a series circuit made up of a resistor 56, which has 10 kiloohms, and a voltage source 58 to the source of the field-effect transistor. The electric series circuit made up of the resistor 56 and the voltage source 58 is connected in parallel to a further switching element 60, such that the gate of the switching element 52 is also connected to the source of the switching element 52 by means of the further switching element 60.

The further switching element 60 is a field-effect transistor, and the gate of the further switching element 60 is connected via a series circuit made up of a further resistor 62 and a further voltage source 64 to the source of the further switching element 60. A DC voltage is provided by means of each of the two voltage sources 58, 64. It is ensured by means of the two resistors 56, 60, which are structurally identical to one another, that no excess current flow takes place between the gate and the source of the respective switching element 52, 60.

A data input 66 is led toward the further voltage source 64 and the further resistor 62. As a result, the gate of the further switching element 62 is connected via the further voltage source 64 to the source of the further switching element 60, wherein the further voltage source 64 is led toward the data output 66, which is connected via the further resistor 62 to the gate of the further switching element 60. The data input 66 is connected to the signal processing unit 10.

A capacitance 68 is connected in parallel to the battery unit 54, and so the battery 18 is also bypassed in the capacitance 58. The capacitance 68 is a capacitor, the capacitance of which is 2 μF.

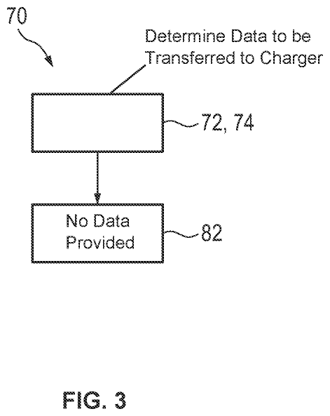

The hearing device 2 is operated according to a method 70 shown in FIG. 3, which is carried out when a magnetic field changing over time is provided by means of the charger 20, with an electric voltage being induced in the receiving coil 34. The electric voltage 36 is applied to the receiving coil here due to the induced electric voltage. As a result of this, an electric current flow results via the rectifier 42, and so the second capacitor 46 is charged. An electric current 71 also results, which flows via the communication unit 26, namely via the diode 50 and via the switching element 52, if it is closed, i.e. is in the electrically conductive state. The capacitance 68 is charged by means of the electric current 71 and the battery 18 is charged by means of the battery unit 54.

Due to the induced electric voltage and the resulting electric current 71, an energy transfer takes place from the charger 20 to the hearing device 2, which is determined by means of the monitoring unit 32.

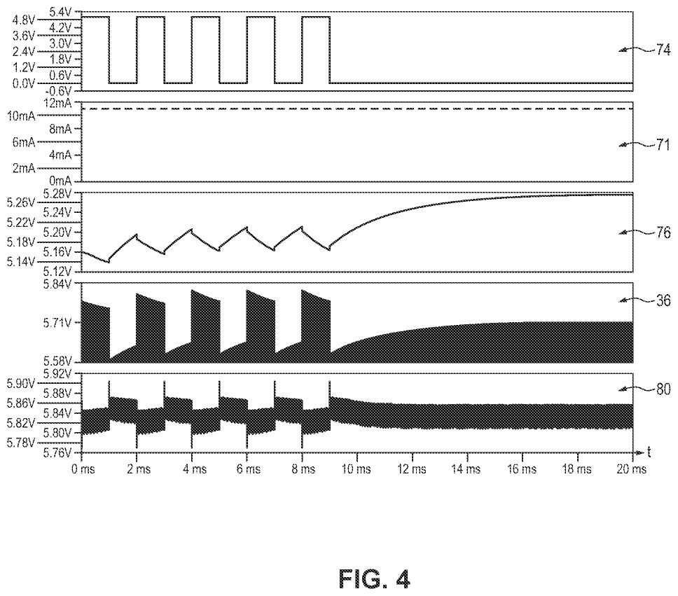

In a first work step 72, data 74 to be transferred from the hearing device 2 to the charging unit 20 are determined. These data are present in this case in binary-coded form and are provided by the signal processing unit 10 via the data input 66. The time curve of the data 74, namely of an electric voltage applied at the data input 66, is shown in FIG. 4, wherein the units shown are arbitrary. The electric voltage applied at the data input 66 is thus either 10 V or 5 V. If the increased electric voltage is applied at the data input 66, i.e. in particular a “high” signal is present, the further switching element 60 is put into the electrically conductive state. As a result, the gate and the source of the switching element 52 are connected to one another with low resistance, as a result of which the switching element 52 is electrically nonconductive. Therefore, only an electric current flow from the charging unit 24 to the battery 18 via the diode 50 is possible, which has an electric resistance.

The electric voltage 36 applied at the receiving coil 34, at least the amplitude, therefore corresponds to the sum of an electric voltage 76 arising via the capacitance 68 plus the electric voltage arising via the diode 50. As a result, the electric voltage 76 applied at the capacitance 68 drops slightly, whereas the electric voltage 36, namely the amplitude, applied at the receiving coil 34 rises. In contrast, if the further switching element 60 is opened due to the data 74, namely the “low” status, the electric voltage provided by means of the voltage source 58 is applied at the gate and the source of the switching element 52, as a result of which the switching element 52 is closed, i.e. put into the electrically conductive state. Consequently, the electric voltage 76 applied at the capacitance 68 approaches the electric voltage applied at the rectifier 42, the level of which is equal to the amplitude of the electric voltage 36 applied at the receiving coil 34. The electric current 71 guided via the communication unit 26 remains constant here, independently of the status of the switching element 52.

In summary, the electric voltage 36 applied at the receiving coil 34 is therefore changed by means of the communication unit 26 as a function of the data 74 to be transferred. For this purpose, the electric resistance of the communication unit 26 is set as a function of the data 74 to be transferred. Due to the essentially constant electric current 71, heating of the hearing device 2, in particular of the charging unit 24 and the battery unit 54, is comparatively minor here.

Any abrupt change of the electric voltage 36 applied at the receiving coil 34 results in a voltage peak, which is registered by means of the monitoring unit 32, in the electric voltage 80 applied at the electric coil 28 of the charging unit 20, namely the amplitude. The data 74 are reconstructed on the basis of the voltage peaks by means of the monitoring unit 32.

If no data 74 are to be transferred, a second work step 82 is carried out. In this step, the further switching element 60 remains open, and so the switching element 52 is closed, as a result of which the level of the electric voltage 76 applied at the capacitance 68 approaches the amplitude of the electric voltage 36 applied at the receiving coil 34. Current peaks therefore no longer result in the electric voltage 80 applied at electric coils 28.

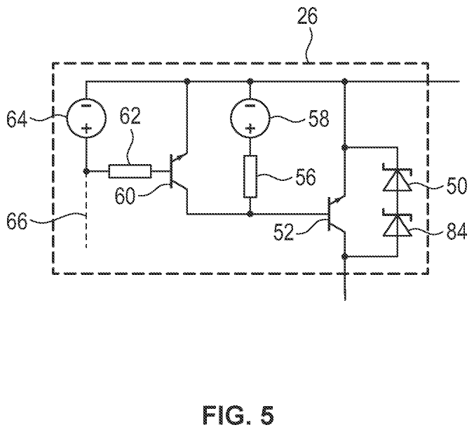

A circuit diagram of a modification of the communication unit 26 is shown in FIG. 5. In comparison to the preceding embodiment, only one second diode 84 is present, which is structurally identical to the diode 50 and is electrically connected in series thereto, wherein the series circuit is bypassed by means of the switching element 52. The switching element 52 is electrically connected in parallel to the series circuit made up of the two diodes 50, 84. Because of the two diodes 50, 84, the change of the electric voltage 36 applied at the receiving coil 34 is increased in the event of a change of the switching state of the switching element 52. In summary, the communication unit 26 therefore comprises the second diode 84, which is electrically connected in series to the diode 50, wherein the series circuit is bypassed by means of the switching element 52.

The invention is not restricted to the above-described exemplary embodiments. Rather, other variants of the invention can also be derived therefrom by a person skilled in the art without departing from the subject matter of the invention. In particular, all individual features described in conjunction with the individual exemplary embodiments can furthermore also be combined with one another in other ways without departing from the subject matter of the invention.

The following is a summary list of reference numerals and the corresponding structure used in the above description of the invention.

### List of Reference Numerals

2 hearing device
4 housing
6 microphone
8 microphone unit
10 signal processing unit
12 receiver
14 sound tube
16 dome
18 battery
20 charger
22 hearing device system
24 charging unit
26 communication unit
28 electric coil
30 activation circuit
32 monitoring unit
34 receiving coil
36 electric voltage applied at the receiving coil
38 first resistor
40 first capacitor
42 rectifier
44 auxiliary diode
46 second capacitor
48 second resistor
50 diode
52 switching element
54 battery unit
56 resistor
58 voltage source
60 further switching element
62 further resistor
64 further voltage source
66 data input
68 capacitance
70 method
71 electric current
72 first work step
74 data
76 electric voltage applied at the capacitance
80 electric voltage applied at the electric coil
82 second work step

1. A method for operating a hearing device having an inductive charger with a receiving coil, a communication unit and a battery electrically connected via the communication unit with the inductive charger, which comprises the steps of:
changing an electric voltage applied at the receiving coil by means of the communication unit in dependence on data to be transferred.

2. The method according to claim 1, which further comprises setting an electric resistance of the communication unit in dependence on the data to be transferred.

3. The method according to claim 1, wherein the hearing device is a hearing aid device.

4. A hearing device, comprising:
an inductive charger having a receiving coil;
a communication unit;
a battery electrically connected via said communication unit to said inductive charger; and
the hearing device being programmed to change an electric voltage applied at said receiving coil by means of said communication unit in dependence on data to be transferred.

5. The hearing device according to claim 4, wherein said communication unit has a switching element and a diode, by means of said diode said inductive charger and said battery are electrically connected, and said diode is bypassed by means of said switching element.

6. The hearing device according to claim 5, wherein said communication unit has a further diode, which is connected in series to said diode and is also bypassed by means of said switching element.

7. The hearing device according to claim 5, wherein:
said communication unit has a voltage source and a further switching element; and
said switching element is a field-effect transistor having a source and a gate connected via said voltage source to said source, wherein said voltage source is bypassed by means of said further switching element.

8. The hearing device according to claim 7, wherein:
said communication unit has a further voltage source and a data input; and
said further switching element is a field-effect transistor having a source and a gate which is connected via said further voltage source to said source, wherein said further voltage source is led toward said data input.

9. The hearing device according to claim 4, further comprising a capacitance and said battery is bypassed using said capacitance.

10. The hearing device according to claim 4, wherein the hearing device is a hearing aid device.

11. A hearing device system, comprising:
said hearing device according to claim 4; and
a charger communicating with said hearing device.
